(19) United States
(12) Patent Application Publication
(10) Pub. No.: US 2012/0192675 A1
(43) Pub. Date: Aug. 2, 2012

(54) MODULAR HOUSING WITH A FIRST HOUSING FOR ACCOMMODATION OF AT LEASET ONE MAIN GEAR

(75) Inventors: Ulrich MAIR, Friedrichshafen (DE); Ruben CÜPPERS, Wangen (DE)

(73) Assignee: ZF FRIEDRICHSHAFEN AG, Friedrichshafen (DE)

(21) Appl. No.: 13/349,826

(22) Filed: Jan. 13, 2012

(30) Foreign Application Priority Data
Jan. 27, 2011 (DE) 10 2011 003 263.0

(51) Int. Cl. F16H 57/02

(52) U.S. Cl. 74/606 R

(57) ABSTRACT

A modular housing, which comprises a first housing assembly for accommodating at least one main transmission by which various gear ratios can be obtained, and whose transmission output shaft can be brought, in an area of the first housing assembly, into functional connection with a drive output of a vehicle that comprises at least one driven vehicle axle. The first housing assembly has an interface, at least in this area, by which the first housing assembly can be connected with an interface of a second housing assembly for accommodating at least one further transmission element. The interface of the first housing assembly is designed as a universal interface for connection of variously designed second housing assemblies with a respectively corresponding interface.

This application claims priority from German patent application serial no. 10 2011 003 263.0 filed Jan. 27, 2011.

### FIELD OF THE INVENTION

The invention concerns a modular housing with a first housing for accommodation of at least one main gear.

### BACKGROUND OF THE INVENTION

From practice various transmission variants are known, for example automatic transmissions, manual shift transmissions, dual clutch transmissions, continuously variable transmissions and the like, which are provided in each case for obtaining various gear ratios in vehicle drive-trains and whose transmission output shafts, in the area of a first housing assembly, can in each case be brought into functional connection with a drive of a vehicle drive-train that comprises at least one driven vehicle axle.

If the transmission variants are used in all-wheel vehicle drive-trains, the transmission variants, each containing a main transmission, are combined with so-termed transfer transmissions in the area of which, in each case, a transmission output torque of the main transmission can be distributed with a predefined degree of distribution or with operating-situation-dependent degrees of distribution between at least two driven axles of the all-wheel vehicle drive-train. Depending on the application concerned, the transfer transmissions are arranged either in a second housing assembly which is connected with the first housing assembly in the area of an interface thereof, or integrated in the housing assembly of the main transmission.

Since the above-mentioned main transmissions are used in both two-wheel drive and four-wheel drive vehicles, the housing assemblies of the main transmission used in two-wheel drive vehicles are designed differently from those used in an all-wheel-drive drive-train. This leads to a large number of housing assembly variants or transmission housings for the main transmission, which in turn results in high production costs of transmissions.

### SUMMARY OF THE INVENTION

Accordingly, the purpose of the present invention is to reduce the number of main transmission housing assembly variants provided for both two-wheel and four-wheel drive vehicles, and thereby to abate the production costs of transmissions.

The modular housing according to the invention is designed with a first housing assembly for accommodating at least one main transmission, by means of which various gear ratios can be obtained and whose transmission output shaft, in the area of the first housing assembly, can be brought into functional connection with a drive output of a vehicle comprising at least one driven vehicle axle. At least in this area the first housing assembly has an interface by which the first housing assembly can be connected to an interface of a second housing assembly for accommodating at least one further transmission element.

According to the invention, the interface of the first housing assembly is designed as a universal interface for the connection of variously configured second housing assemblies with respective corresponding interfaces.

In the modular housing according to the invention the first housing assembly for accommodating at least one main transmission for any field of application of a main transmission, i.e. in particular for use in a two-wheel drive vehicle and also in an all-wheel vehicle drive-train, is standardized in that the first housing assembly is made as a standard transmission housing and is provided in the area of the transmission output shaft with a universal interface, in the area of which variously designed second housing assemblies can be attached by means of corresponding interfaces.

Thus, in a simple and inexpensive manner the first housing assembly for accommodating at least one main transmission can be connected on the transmission output side, by means of an interface of standard design, to a variety of second housing assemblies adapted for different applications, which can be designed in various ways for the accommodation of at least one further transmission element.

In an embodiment of the modular housing according to the invention that can be assembled simply, the interface of the first housing assembly and the interface of the second housing assembly are formed at least in part with flange-like sections in the area of which the housing assemblies can be connected to one another by fastening means, in particular screw joints.

If the second housing assembly is provided for accommodating a transmission element in the form of a shaft that can be connected to the transmission output shaft, the main transmission arranged in the standardized housing assembly or first housing assembly can be combined with little design effort preferably with at least one further housing assembly, the screwed-on area of which does not correspond to the interface of the first housing assembly. The second housing assembly then functions as an adaptor which is arranged in a simple and inexpensive manner between the first housing assembly and various other housing assemblies.

In a further advantageous embodiment of the modular housing, the second housing assembly is designed to accommodate a further transmission element designed as a drive output flange that can be brought into functional connection with the shaft, which can be coupled to the at least one driven vehicle axle of the drive output. Then, the first housing assembly of standardized design intended to accommodate the main transmission and essentially suitable for all likely application options can be fitted into a two-wheel drive vehicle with little effort and at the same time with low production costs.

If a further transmission element in the form of a transfer transmission is arranged in the second housing assembly between the shaft and the output flange, such that a first shaft of the transfer transmission is coupled to the shaft that can be connected to the transmission output shaft of the main transmission, a second shaft of the transfer transmission is connected to the output flange that can be brought into functional connection with a driven vehicle axle of the drive output, and a third shaft of the transfer transmission can be brought into functional connection with at least one further driven vehicle axle of the drive output, the main transmission arranged in the standardized or first housing assembly can be integrated into the drive-train of an all-wheel vehicle inexpensively and without having to make structural modifications in the area of the first housing assembly.

Independently of this, the transfer transmission can be designed both as a so-termed add-on transfer box formed with an actuating device independent of the actuator of the main transmission, and as an integrated transfer transmission whose actuating device has to be connected to the actuator of the main transmission.

When, in the area of the interface of the first housing assembly, a connection device with an actuating device of the main transmission which is associated with the first housing assembly and is preferably electro-hydraulic is provided, then the first housing assembly is prepared for the connection of a so-termed transfer transmission which can be operated by means of the electro-hydraulic actuator of the main transmission.

In a further advantageous embodiment of the modular housing, by means of the connecting device an actuating system associated with the second housing assembly, which is provided at least for actuating the transfer transmission, can be brought into functional connection with the actuating device of the first housing assembly, whereby in the area of the second housing assembly no additional pressure source such as a hydraulic pump or the like for providing an actuating pressure for the operation of the transfer transmission need be provided. In this case the actuating pressure for operating the transfer transmission can be specified or set, depending on the application concerned, in the area of the actuating device of the first housing assembly and/or in the area of the actuating device of the second housing assembly.

If the second housing assembly is provided as an adaptor between the first housing assembly and a third housing assembly, the shaft provided in the area of the second housing assembly and which can be connected to the transmission output shaft of the main transmission, can be brought into functional connection with a shaft of a transfer transmission device arranged in the third housing assembly, and in that case the second housing assembly can be connected in a simply designed manner, in the area of a further interface, to a corresponding interface of the third housing assembly.

In a further embodiment of the modular housing which is simple to assemble and is characterized by little design complexity, the interface of the second housing assembly and the interface of the third housing assembly are formed at least in part with flange-like sections in the area of which the housing assemblies can be jointed to one another by fixing means, preferably by screw joints.

If the transfer transmission arranged in the third housing assembly is designed as an integrated transfer transmission which is operated at least partially by the actuating device of the first housing assembly, then the second housing assembly is made with a bridging device by means of which a connection can be formed between the actuating device of the first housing assembly and a further actuating system associated with the third housing assembly, which is provided for actuating the transfer transmission device.

Both the characteristics indicated in the claims and those indicated in the following example embodiments of the modular housing according to the invention are in each case appropriate, whether considered in isolation or in any desired combination with one another, as further developments of the object according to the invention. In relation to the further development of the object of the invention the respective combinations of characteristics do not represent any limitation, but are presented essentially only as examples.

### BRIEF DESCRIPTION OF THE DRAWINGS

Further advantages and advantageous further developments of the invention emerge from the example embodiments whose principle is described with reference to the drawing; for the sake of clarity, in the description the same indexes are used for components having the same structure and function.

The drawing shows:

FIG. 1: A very schematic representation of a first housing assembly of the modular housing according to the invention;

FIG. 2: The first housing assembly as in FIG. 1 in combination with a first embodiment of a second housing assembly for use in a two-wheel drive vehicle;

FIG. 3: The first housing assembly as in FIG. 1 in combination with a second embodiment of a second housing assembly for use in a four-wheel drive vehicle, with an integrated transfer transmission arranged in the second housing assembly; and

FIG. 4: A further embodiment of the modular housing, in which the first housing assembly as in FIG. 1 is connected by a second housing assembly designed as an adaptor to a third housing assembly with a so-termed add-on transfer transmission arranged therein.

### DETAILED DESCRIPTION OF THE PREFERRED EMBODIMENTS

FIG. 1 shows a modular housing 1 with a first housing assembly 2 in which is fitted a main transmission 3. In this case the main transmission 3 is in the form of an automatic transmission but, depending on the application, it could also be a manual shift transmission, a dual clutch transmission, a continuously variable transmission or the like. In the area of the main transmission 3 in each case various gear ratios for forward and reverse driving can be produced.

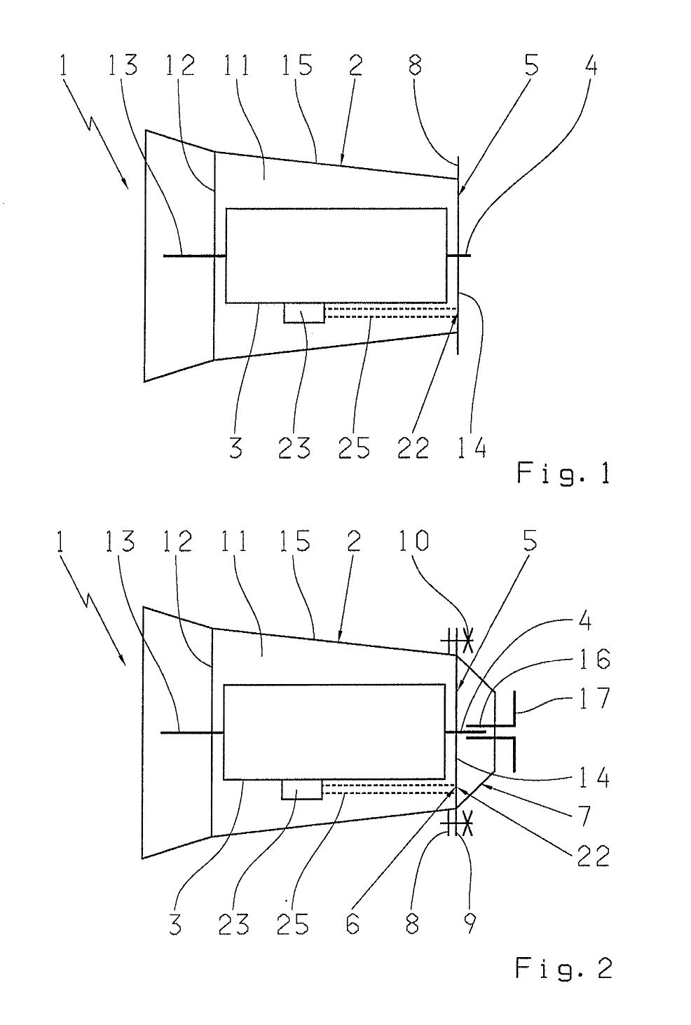

A transmission output shaft 4, which in the area of the interface 5 of the first housing assembly 2 emerges from the first housing assembly 2 through the plane formed by the interface 5, can be brought into functional connection, in a lateral area of the first housing assembly 2, particularly when the main transmission 3 is arranged longitudinally in the vehicle, with a drive output of the vehicle that comprises at least one driven vehicle axle, the first housing assembly 2 having in this area an interface 5 of universal design or a screw-on area. Onto the interface 5 of the first housing assembly 2, FIGS. 2 to 4 show respective examples in each case of a corresponding interface 6 of a second housing assembly 7 that can be attached. The second housing assembly 7 is in each case designed to accommodate at least one further transmission element.

Both the interface 5 of the first housing assembly 2 and the interface 6 of the second housing assembly 7 are formed, at least in part, with flange-like sections 8, 9 in whose area the housing assemblies 2 and 7 can be connected firmly to one another with little assembly effort, by fixing means 10 preferably in the form of screw joints.

The first housing assembly 2 provided for accommodating the main transmission 3 is a standardized transmission housing made on the transmission output side with the interface 5, namely a universal screw-on face, onto which can be fitted various other screw-on faces 6 of second housing assemblies 7 that are compatible with the universal screw-on face 5 of the main transmission housing 2.

In the present case an inside space 11 of the first housing assembly 2 is delimited on the transmission input side by a centering plate 12 in the area of which a transmission input shaft 13 that can be coupled to a drive machine of a vehicle drive-train is mounted so that it can rotate. On the transmission output side the inside space 11 of the first housing assembly 2 is delimited by a cover element 14 provided in the area of the interface 5, in which the transmission output shaft 4 is mounted and able to rotate and which, depending on the application concerned, is connected releasably to or made integrally with a housing area 15 that delimits the inside space 11 in the radial direction. In the integral version of the cover element 14 and the housing area 15, the centering plate 12 is in turn releasably connected to the housing area 15, in order to be able to fit into the inside space lithe transmission elements that are to be arranged in the first housing assembly 2, such as the main transmission 3 itself and other transmission elements provided for operating the main transmission 3.

Like the first housing assembly 2, the transmission output shaft 4 is of standardized design and is brought into functional connection with the drive output of a vehicle drive-train comprising one or more driven vehicle axles, by way of other transmission elements accommodated in the area of the second housing assembly 7 and in the manner described in more detail below.

In the example embodiment of the modular housing shown in FIG. 2, in the area of the interfaces 5 and 6 the first housing assembly 2 is connected firmly to a second housing assembly 7 which accommodates a transmission element 16 in the form of a shaft connected in a rotationally fixed manner to the transmission output shaft 4 of standardized design, and a further transmission element 17 in the form of a drive output flange 17 connected in a rotationally fixed manner to the shaft 16. In a manner known per se, the output flange 17 can be coupled to the at least one driven vehicle axle of the drive output of a two-wheel drive vehicle, and is mounted both in the area of the shaft 16 and in the area of the second housing assembly 7. Otherwise, it is also possible to mount the output flange 17 in the area of the first housing assembly 2 and the second housing assembly 7.

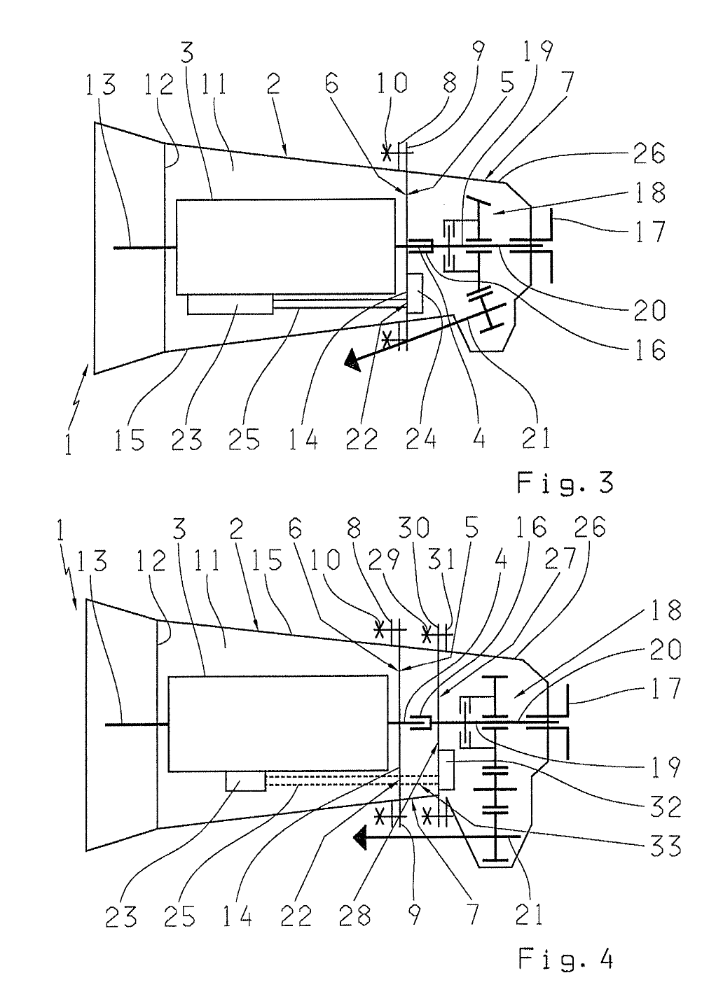

In the further example embodiment of the modular housing 1 shown in FIG. 3, between the shaft 16 and the output flange 17 in the second housing assembly 7 there is arranged another transmission element 18 in the form of a transfer transmission. In this case a first shaft 19 of the transfer transmission 18 is connected rotatably to the shaft 16 that can be connected to the transmission output shaft 4 of the main transmission 3. A second shaft 20 of the transfer transmission 18 is functionally connected in a rotationally fixed manner to the output shaft 17 that can be coupled to a first driven vehicle axle of the drive output. In turn, a third shaft 21 of the transfer transmission 18 can be connected to at least one further driven vehicle axle of the drive output.

In the area of the interface 5 of the first housing assembly 2 is provided a connecting device 22, by means of which a preferably electro-hydraulic actuating device 23 of the main transmission 3 associated with the first housing assembly 2 and an actuating device 24 associated with the second housing assembly, in this case in the form of a hydraulic control unit provided for actuating the transfer transmission 18, can be brought into functional connection hydraulically and preferably electrically as well.

The connecting device 22 has hydraulic ducts 25 that open out in the area of the interface 5, by virtue of which the coupling between the actuating device 23 of the first housing assembly 2 and the actuating device 24 of the second housing assembly 7 can be produced. In addition, the actuating device 24 of the second housing assembly 7 can preferably be fitted in the area of the connecting device 22.

FIG. 4 shows a third embodiment of the modular housing 1, in which the shaft 16 provided in the area of the second housing assembly 7 and that can be connected to the transmission output shaft 4, is in functional connection with a shaft 19 of a transfer transmission 18 arranged in a third housing assembly 26. By means of further fixing means 29 preferably in the form of screw joints, in the area of another interface 27 the second housing assembly 7 can be connected firmly to a corresponding interface 28 of the third housing assembly 26. The interface 27 of the second housing assembly 7 and the interface 28 of the third housing assembly 26 are at least in part formed with flange-like sections 30, 31, in the area of which the housing assemblies 7 and 26 are screwed to one another by means of the fixing means 29.

The modular housing 1 shown in FIG. 4 is also designed to be suitable for use in an all-wheel transfer drive-train, wherein the main transmission 3 is combined with an add-on transfer transmission 18. The second housing assembly 7 is provided as an adaptor, since the interface 28 of the third housing assembly 26 is not compatible with the interface 5 of the first housing assembly 2.

In general, however, to reduce the structural space needed, efforts are made to accommodate an add-on transfer transmission as well in the second housing assembly in the manner shown in more detail in FIG. 3 and to connect the second housing assembly 7 directly to the universal screw-on face or interface 5 of the first housing assembly 2.

In order also to be able to combine the main transmission 3 arranged in the first housing assembly 2 by means of the second housing assembly 7 designed as an adaptor flange with an integrated transfer transmission arranged in the third housing assembly 26 instead of with an add-on transfer transmission, the second housing assembly 7 can also optionally be made with a bridging device 33 by means of which, in the area of the second housing assembly 7, a connection can be formed between the actuating device 23 of the first housing assembly 2 and the further actuating device 32 associated with the third housing assembly 26, which is provided for actuating the integrated transfer transmission 18. In that case the bridging device 33 connects the actuating device 23 between the connecting device 22 in the area of the interface 5 to the interface 27 of the second housing assembly 7, in whose area, in turn, the actuating device 32 can be fitted.

### INDEXES

1 Modular housing
2 First housing assembly
3 Main transmission
4 Transmission output shaft
5 Interface of the first housing assembly
6 Interface of the second housing assembly
7 Second housing assembly
8, 9 Flange-like section
10 Fixing means
11 Inside space
12 Centering plate
13 Transmission output shaft
14 Cover element
15 Housing area
16 Transmission element, shaft
17 Further transmission element, drive output flange
18 Further transmission element, transfer transmission
19, 20, 21 Shaft of the transfer transmission
22 Connecting device
23 Actuating device of the first housing assembly
24 Actuating device of the second housing assembly
25 Hydraulic duct
26 Third housing assembly
27 Further interface of the second housing assembly
28 Interface of the third housing assembly
29 Further fixing means
30, 31 Flange-like section
32 Actuating device of the third housing assembly
33 Bridging device

1-10. (canceled)

11. A modular housing (1) comprising:
a first housing assembly (2) for accommodating at least one main transmission (3) by which various gear ratios are obtainable,
a transmission output shaft (4) of the at least one main transmission (3) being functionally connectable, in an area of the first housing assembly (2), with a drive output of a vehicle that comprises at least one driven vehicle axle,
the first housing assembly (2) having an interface (5), at least in the area of the first housing assembly (2), by which the first housing assembly (2) being connectable with an interface (6) of a second housing assembly (7),
the second housing assembly (7) accommodating at least one further transmission element (16; 16, 17; 16, 17, 18), and
the interface (5) of the first housing assembly (2) being a universal interface for the connection of variously designed second housing assemblies (7) with a respectively corresponding interface (6) of the second housing assembly (7).

12. The modular housing according to claim 11, wherein the interface (5) of the first housing assembly (2) and the interface (6) of the second housing assembly (7) are formed, at least in part, with flange-like sections (8, 9) in the area in which the first and the second housing assemblies (2, 7) are connectable to one another by fixing means (10).

13. The modular housing according to claim 11, wherein the second housing assembly (7) accommodates a transmission element (16) in the form of a shaft that is connectable to the transmission output shaft (4).

14. The modular housing according to claim 13, wherein the second housing assembly (7) accommodates a further transmission element (17) that is functionally connectable with the shaft (16) and is in the form of a drive output flange, which is couplable to the at least one driven vehicle axle of the drive output.

15. The modular housing according to claim 14, wherein in the second housing assembly (7), between the shaft (16) and the output flange (17), a further transmission element (18), designed as a transfer transmission, is arranged such that a first shaft (19) of the transfer transmission (18) is coupled to the shaft (16) that is connectable to the transmission output shaft (4) of the main transmission (3), a second shaft (20) of the transfer transmission (18) is connected to the output flange (17) that is connectable with the driven vehicle axle of the drive output, and a third shaft (21) of the transfer transmission (18) is functionally connectable with at least one further driven vehicle axle of the drive output.

16. The modular housing according to claim 11, wherein a connecting device (22) with an actuating device (23) of the main transmission (3), which is associated with the first housing assembly (2) and which is electro-hydraulic, is provided in the area of the interface (5) of the first housing assembly (2).

17. The modular housing according to claim 16, wherein an actuating device (24) associated with the second housing assembly (7), which is provided at least for actuating the transfer transmission (18), is functionally connectable, via the connecting device (22), with the actuating device (23) of the first housing assembly (2).

18. The modular housing according to claim 13, wherein the shaft (16) which is provided in the area of the second housing assembly (7) and is connectable to the transmission output shaft (4), is functionally connectable with a shaft (19) of a transfer transmission (18) arranged in a third housing assembly (26) such that the second housing assembly (7) is connected in an area of a further interface (27) to an interface (28) of the third housing assembly (26) that corresponds therewith.

19. The modular housing according to claim 18, wherein the further interface (27) of the second housing assembly (7) and the interface (28) of the third housing assembly (26) are formed, at least in part, with flange-like sections (30, 31), in the area of which the second housing assembly (7) and the interface (28) of the third housing assembly (26) are connected to one another by fixing means (29).

20. The modular housing according to claim 18, wherein the second housing assembly (7) is provided with a bridging device (33) by which a connection is formable between an actuating device (23), of the first housing assembly (2), and a further actuating device (32) provided for actuating the transfer transmission (18), associated with the third housing assembly (26).

21. A modular housing (1) comprising:
at least one main transmission (3) for engaging a variety of gear ratios, the at least one main transmission (3) being housed within a first housing assembly (2) and comprising a transmission output shaft (4), and the first housing assembly (2) comprising an interface (5);
at least one further transmission element (16; 16, 17; 16, 17, 18) being housed within a second housing assembly (7), the second housing assembly (7) comprising an interface (6) for mating with the interface (5) of the first housing assembly (2);
the interface (5) of the first housing assembly (2) being a universal interface and being connectable with the interface (6) of the second housing assembly (7) such that the transmission output shaft (4) is functionally connectable, in an area of connection between the interfaces (5, 6) of the first and the second housing assemblies (2, 7), to a drive output of a vehicle comprising at least one driven vehicle axle.
